(19) United States
(12) Patent Application Publication
(10) Pub. No.: US 2025/0187091 A1
(43) Pub. Date: Jun. 12, 2025

(54) VIBRATION-ASSISTED GENERATING MACHINING

(71) Applicants: REISHAUER AG, Wallisellen (CH); FRAUNHOFER-GESELLSCHAFT ZUR FÖRDERUNG DER ANGEWANDTEN FORSCHUNG E.V, München (DE)

(72) Inventors: Maximilian ZIMMER, Wallisellen (CH); Martin MÄDLOW, Freiberg (DE)

(73) Assignees: REISHAUER AG, Wallisellen (CH); FRAUNHOFER-GESELLSCHAFT ZUR FÖRDERUNG DER ANGEWANDTEN FORSCHUNG E.V, München (DE)

(21) Appl. No.: 18/843,793

(22) PCT Filed: Mar. 10, 2023
(86) PCT No.: PCT/EP2023/056184

§ 371 Date: Sep. 4, 2024

(30) Foreign Application Priority Data
Mar. 21, 2022 (CH) 000301/2022

(51) Int. Cl. B23F 5/04; B06B 1/06; B23F 23/12

(52) U.S. Cl. CPC B23F 5/04; B06B 1/0614; B23F 23/1293

(57) ABSTRACT

A method of generating machining of a gear-shaped workpiece (23), in particular by continuous generating grinding, in which the gear-shaped workpiece rotates about a workpiece axis (C) while in generating mesh with a generating machining tool. During machining, the gear-shaped workpiece performs an oscillating movement which is superimposed on the rotation of the gear-shaped workpiece. Also disclosed are a clamping device (22) configured to perform the method, and a system comprising such a clamping device and a control device (50). Finally, a generating machining machine comprising a clamping device of the mentioned type is also disclosed.

### TECHNICAL FIELD

The present invention relates to a method for machining a gear-shaped workpiece by a generating machining process, in particular by continuous generating grinding, a clamping device adapted to carry out the method, a system for generating oscillating movements of a gear-shaped workpiece during machining by a generating machining process, and a generating grinding machine on which the clamping device is used.

### PRIOR ART

The final hard finishing in gear manufacturing is one of the most important machining steps with regard to the gear quality achieved. This is where the geometry that will later be in tooth mesh is being produced. A method frequently used for hard finishing is continuous generating grinding. In continuous generating grinding, a gear-shaped workpiece is machined in rolling engagement with a grinding tool in the form of a worm-shape profiled grinding wheel (grinding worm). Generating gear grinding is a very demanding machining process based on a large number of synchronized, precise individual movements and influenced by many boundary conditions. Information on the fundamentals of continuous generating grinding can be found, for example, in Ref. [1].

FIG. 1 illustrates an example of the mesh between a generating machining tool in the form of a grinding worm 16 and a helical gear 23 during continuous generating grinding. The grinding worm 16 rotates about a tool axis B, while the gear wheel 23 rotates about a workpiece axis C. In this process, the grinding worm 16 and the gear wheel 23 mesh with each other in the manner of a worm drive (so-called roll coupling or generating coupling).

During a grinding pass, an axial feed motion of the grinding worm 16 relative to the gear wheel 23 takes place along a feed axis Z, which runs parallel to the workpiece axis C. At the same time, the grinding worm 16 is continuously moved translationally along a Y-direction that runs parallel to the tool axis B in order to continuously bring fresh worm material into mesh with the gear wheel 23 (so-called shifting movement). Along an infeed axis X, the grinding worm 16 is fed in a radial direction with respect to the gear wheel 23.

As a result of the complex cutting motion between the grinding worm 16 and the gear wheel 23, regular wave-like structures form on the tooth flanks along the flank line direction (so-called grinding grooves). These regular structures can lead to undesirable noise development when the gear wheels are in use.

In the prior art, various approaches have been proposed for the subsequent elimination of such regular structures. For example, it has been suggested to add a polishing grinding process or a honing process downstream of the continuous generating grinding process. However, such an additional process step is often associated with an undesirable cost increase.

It has also been proposed in the prior art to take measures to avoid the formation of the aforementioned regular structures from the outset. In the so-called Low Noise Shifting (LNS), for example, the rotation angles of the grinding worm and the dressing wheel are coupled during dressing. By a deliberately adapted shifting movement during grinding, the periodic fluctuations in the grinding pattern are deliberately placed in such a way that a more favorable noise behavior of the gear is achieved (see Ref. [2]). Due to the increasing process complexity, this method does not completely cover all noise-critical applications.

In Ref. [30] it is proposed to generate a specific waviness during continuous generating grinding by exploiting a specific unbalance of the tool.

Undesirable regular structures can also result from other generating machining processes such as gear skiving.

### SUMMARY OF THE INVENTION

In a first aspect, it is an object of the present invention to provide a method for generating machining of gear-shaped workpieces, in particular for continuous generating grinding, with which undesirable regular structures on the flanks of the machined workpieces can be reduced.

This object is solved by a method according to claim 1. Further embodiments are defined in the dependent claims.

The invention proposes a method for machining a gear-shaped workpiece, in particular its tooth flanks, by a generating machining process, in particular by continuous generating grinding. During machining, the gear-shaped workpiece rotates about a workpiece axis while in generating mesh with a generating machining tool, in particular a worm-shape-profiled grinding tool, which rotates about a tool axis. The method is characterized by the fact that the gear-shaped workpiece carries out an oscillating movement during machining, which is superimposed on the rotation of the gear-shaped workpiece. This modifies the meshing between the workpiece and the tool in such a way that the surface structure of the workpieces thus produced can be improved. In particular, regular structures such as grinding grooves can be avoided or interrupted.

The oscillating movement of the gear-shaped workpiece preferably has a component along at least one of the following directions of movement:
axial along the workpiece axis;
radial to the workpiece axis; and
torsional around the workpiece axis.

In particular, the oscillating movement may correspond to a superposition of components along these directions of movement.

In some embodiments, the oscillating movement has a fundamental frequency above 15 kHz. In other words, in such embodiments, the oscillating movement is a vibration in the ultrasonic range. As will be described in more detail below, such movements can be generated particularly efficiently by resonant excitation of a clamping device on which the workpiece is clamped. In other embodiments, the fundamental frequency is below 15 KHz. The term “fundamental frequency” designates the spectral component of the vibration which has the lowest frequency.

The oscillating movement can be generated in particular as follows: The gear-shaped workpiece is clamped on a clamping device during the generating grinding operation, the clamping device in turn being arranged on a workpiece spindle. The workpiece spindle drives the gear-shaped workpiece clamped on the clamping device to rotate about the workpiece axis. The clamping device has a clamping portion which is in direct contact with the workpiece clamped on the clamping device. The oscillating movement of the gear-shaped workpiece is then preferably generated by exciting a vibration of the clamping portion of the rotating clamping device. This excitation is preferably resonant, so that the vibration is an eigenmode of the clamping device with the gear-shaped workpiece clamped thereon. In this way, a controlled excitation with high amplitude can be achieved. The corresponding eigenfrequencies (resonant frequencies) are typically in the ultrasonic range. In order to reduce undesired transmission of the vibration to the workpiece spindle, the eigenmode is preferably selected in such a way that a vibration node of the eigenmode is located in a mounting region of the clamping device which is in contact with the workpiece spindle.

To excite the vibration, the clamping device can have a vibration generator integrated in the clamping device. The vibration generator converts an electrical excitation signal in the form of an AC voltage with a suitable frequency into a vibration of the clamping device with the gear-shaped workpiece being clamped thereon. To monitor the vibration caused by the excitation signal, an electrical sensor signal can be determined that characterizes the vibration. The excitation signal can then be controlled using the sensor signal such that the excitation of the vibration is resonant, as explained as above. In particular, the sensor signal may characterize the amplitude of the generated vibration and/or the phase position of the generated vibration relative to the excitation signal. Based on such a sensor signal, the control of the excitation signal (in particular of its frequency) can then be performed in such a way that the oscillating system consisting of the clamping device and the gear-shaped workpiece clamped thereon is resonantly excited as desired. Suitable control algorithms for controlling the excitation of an oscillating system such that the system oscillates resonantly are generally known.

Preferably, the excitation signal and the sensor signal are transmitted in a contactless manner between the rotating clamping device and a stationary control device. The control device may in particular comprise a frequency generator for generating the excitation signal and a controller for the control of the excitation signal described above. Suitable devices for contactless transmission of energy and of signals are known per se. For example, the transmission can be effected inductively by two coils arranged concentrically around the workpiece axis, one of the coils being arranged on the clamping device and the other coil on the stationary machine element.

In a second aspect, the invention provides a clamping device for clamping a gear-shaped workpiece on a workpiece spindle of a gear cutting machine, in particular a generating grinding machine, which is configured for carrying out the above-described method according to the first aspect of the invention. The clamping device is characterized in that it comprises a vibration generator for generating a vibration of the clamping device with the gear-shaped workpiece clamped thereon.

In particular, the vibration generator may be configured to generate a vibration excitation along at least one of the following directions of movement:
axial along the workpiece axis;
radial to the workpiece axis; and
torsional around the workpiece axis.

In preferred embodiments, the vibration generator comprises a piezo actuator or is designed as a piezo actuator. In particular, the vibration generator of the vibration generator may comprise at least one piezoelectric actuator element that is disk-ring-shaped or ring-segment-shaped, wherein a ring axis of the piezoelectric actuator element corresponds to the workpiece axis.

The vibration generator may be disposed in the clamping device as follows: the clamping device defines a proximal end and a distal end, wherein the proximal end is adapted for connection to the workpiece spindle. The clamping device includes a clamping portion configured to make direct contact with the gear-shaped workpiece. The clamping portion can be configured, for example, in a manner known per se as a hydraulically actuated expansion sleeve or as a mechanically actuated segmented clamping bushing. The vibration generator can then be arranged between the proximal end and the clamping portion, or it can be arranged distally from the clamping portion.

The clamping device may further comprise a vibration sensor for determining at least one sensor signal, the sensor signal characterizing the vibration of the clamping device with the gear-shaped workpiece clamped thereon.

The vibration sensor can in particular comprise a piezo sensor or be configured as a piezo sensor. It can be built analogously to the vibration generator and have at least one piezoelectric sensor element that is disk-ring-shaped or ring-segment-shaped, with a ring axis of the piezoelectric sensor element corresponding to the workpiece axis. The vibration generator and the vibration sensor may together form a vibration transducer comprising a stack of disk-ring-shaped or ring-segment-shaped piezoelectric elements, disk-ring-shaped electrodes, and disk-ring-shaped isolation disks.

In a third aspect, the present invention provides a system for generating an oscillating movement of a gear-shaped workpiece during machining by a gear machining process, in particular by continuous generating grinding. On the one hand, the system comprises a clamping device according to the second aspect of the invention. On the other hand, the system comprises a frequency generator for generating an excitation signal for the vibration generator to cause the clamping device to vibrate with the gear-shaped workpiece clamped thereon. The system may include a controller adapted to receive the sensor signal and, based on the sensor signal, to control the excitation signal such that the excitation of the vibration occurs resonantly.

The system may further comprise a transmission device for contactless transmission of the excitation signal and the sensor signal between the rotating clamping device and the stationary control device, as already explained above in the context of the method.

In a fourth aspect, the invention provides a generating machining machine, in particular a generating grinding machine, configured to perform the method according to the first aspect of the invention. The generating machining machine comprises:
a tool spindle for driving a generating machining tool, in particular a worm-shape-profiled grinding tool, to rotate about a tool axis;
a workpiece spindle for driving the gear-shaped workpiece to rotate about the workpiece axis; and
a machine controller configured to control the tool spindle and the workpiece spindle in such a way that a roll coupling is established between the rotation of the tool generated by the tool spindle and the rotation of the workpiece generated by the workpiece spindle.

The generating machining machine is characterized in that a clamping device is mounted on the workpiece spindle according to the second aspect of the invention. Of course, the generating machining machine may further comprise a frequency generator, a controller and/or a transmission device as indicated in the third aspect of the invention.

### BRIEF DESCRIPTION OF THE DRAWINGS

Preferred embodiments of the invention are described below with reference to the drawings, which are for explanatory purposes only and are not to be interpreted restrictively. In the drawings:

FIG. 1 shows a sketch explaining the kinematics of continuous generating grinding;

FIG. 2 shows a schematic view of a generating grinding machine;

FIG. 3 show a schematic sketch showing possible vibration types and shapes of a clamping device with a gear clamped thereon;

FIG. 4 shows a schematic view of a clamping device with a gear wheel clamped thereon, with a vibration transducer arranged above the gear wheel for generating and measuring torsional movements of the gear wheel, together with an associated control device and a possible vibration mode;

FIG. 5 shows a schematic exploded view of a vibration transducer being a vibration generator on the one hand and a vibration sensor on the other hand;

FIG. 6 shows a schematic view of a clamping device with a gear wheel mounted thereon, with a vibration transducer arranged below the gear wheel for generating and measuring oscillating torsional movements of the gear wheel, as well as a possible vibration mode;

FIG. 7 shows a schematic view of a clamping device with a gear wheel mounted thereon, with a vibration transducer arranged above the gear wheel for generating and measuring oscillating longitudinal movements of the gear wheel, as well as a possible vibration mode;

FIG. 8 shows a schematic view of a clamping device with a gear wheel mounted thereon, with a vibration transducer arranged below the gear wheel for generating and measuring oscillating longitudinal movements of the gear wheel, as well as a possible vibration mode;

FIG. 9 shows a schematic view of a clamping device with a gear wheel mounted thereon, with a vibration transducer arranged above the gear wheel for generating and measuring oscillating radial movements of the gear, as well as a possible vibration mode; and

FIG. 10 shows a schematic view of a clamping device with a gear wheel mounted thereon, with a vibration transducer arranged below the gear wheel for generating and measuring oscillating radial movements of the gear wheel, as well as a possible vibration mode.

### DESCRIPTION OF PREFERRED EMBODIMENTS

### Exemplary Structure of a Generating Grinding Machine

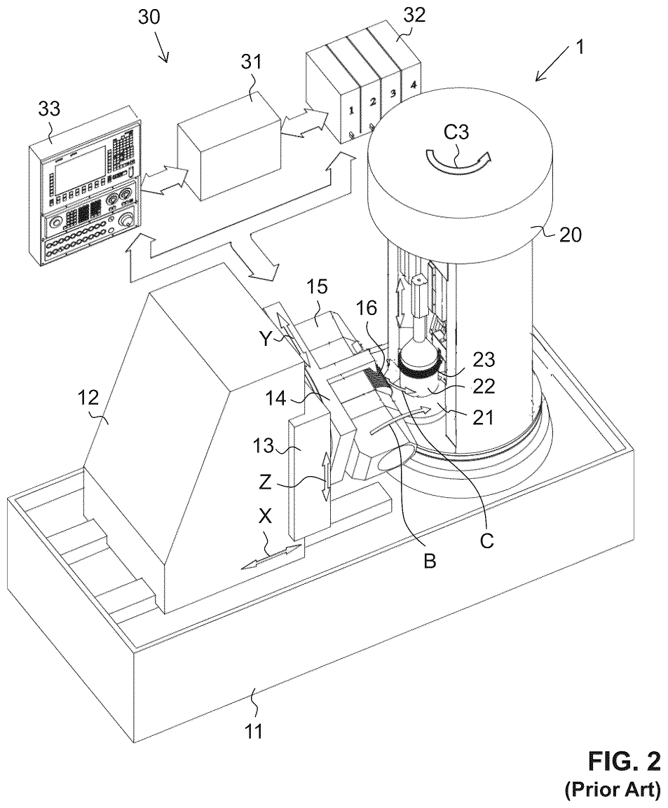

FIG. 2 shows an example of a generating grinding machine 1 as it is known from the prior art. The machine has a machine bed 11 on which a tool carrier 12 is displaceably guided along an infeed direction X. The tool carrier 12 carries an axial slide 13, which is displaceably guided along an axial direction Z relative to the tool carrier 12. A grinding head 14 is mounted on the axial slide 13, the grinding head 14 being pivotable about a pivot axis (the so-called A-axis) running parallel to the X-axis in order to adapt to the helix angle of the gear to be machined. The grinding head 14 in turn carries a shift slide on which a tool spindle 15 can be shifted along a shift axis Y relative to the grinding head 14. A grinding worm 16 is clamped on the tool spindle 15. The grinding worm 16 is driven by the tool spindle 15 to rotate about a tool axis B.

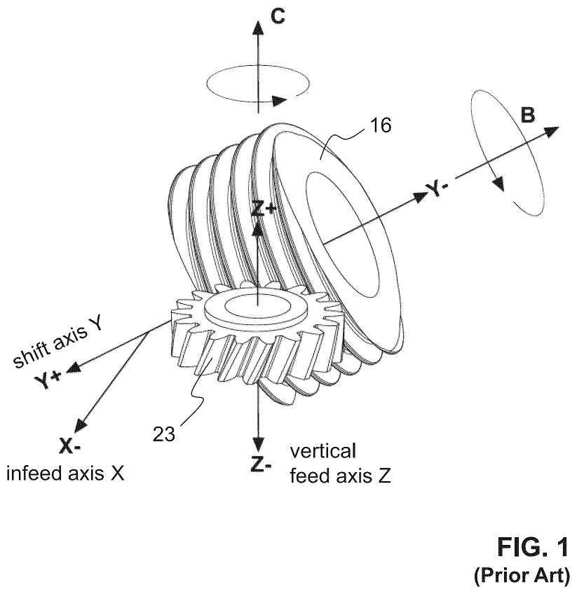

The machine bed 11 further supports a pivotable workpiece carrier 20 in the form of a rotary turret, which can be pivoted about an axis C3 between at least two positions. Two identical workpiece spindles 21 are mounted diametrically opposite each other on the workpiece carrier 20, only one of which is visible in FIG. 1. A clamping device 22 for clamping a workpiece 23 is mounted on each of the workpiece spindles. The workpiece spindle visible in FIG. 1 is in a machining position in which the workpiece 23 clamped on the clamping device 22 can be machined with the grinding wheel 16. The other workpiece spindle, which is offset by 180° and is not visible in FIG. 1, is in a workpiece change position in which a finished machined workpiece can be removed from the clamping device on this spindle and a new blank can be clamped on. Each workpiece spindle 21 drives the clamping device 22 mounted on it with the workpiece 23 clamped on it to rotate about a workpiece axis C.

All driven axes of the generating grinding machine 1 are digitally controlled by a machine control 30. The machine control 30 receives sensor signals from a plurality of sensors in the generating grinding machine 1 and outputs control signals to the actuators of the generating grinding machine 1 as a function of these sensor signals. In particular, the machine control system 30 comprises a plurality of axis modules (NC modules) 32, which provide control signals at their outputs for a respective machine axis (i.e. for at least one actuator used to drive the respective machine axis, such as a servomotor). It further comprises an operator panel 33 and a control computer 31 that interacts with the operator panel 33 and the axis modules 32. The control computer 31 receives operator commands from the control panel 33 and sensor signals, and calculates control commands for the axis modules 32 based thereon. It furthermore outputs operating parameters based on the sensor signals to the control panel 33 for display.

### Machining of a Workpiece Lot

In order to machine a workpiece that is still unmachined (a blank), the workpiece is clamped by an automatic workpiece changer on the clamping device of the workpiece spindle that is in the workpiece change position. The workpiece change takes place in parallel with the machining of another workpiece on the other workpiece spindle that is in the machining position. When the new workpiece to be machined is clamped and machining of the other workpiece is completed, the workpiece carrier 20 is swiveled 180° about the C3 axis so that the spindle with the new workpiece to be machined moves to the machining position. Before and/or during the swiveling process, a meshing operation is performed with the aid of a meshing probe. For this purpose, the workpiece spindle 21 is set in rotation, and the position of the tooth gaps of the workpiece 23 is measured with the aid of the meshing probe. The roll angle is determined on this basis.

When the workpiece spindle carrying the workpiece 23 to be machined has reached the machining position, the workpiece 23 is brought into collision-free meshing with the grinding wheel 16 by moving the tool carrier 12 along the X axis. The workpiece 23 is now machined by the grinding wheel 16 in generating meshing. In the meantime, the tool spindle 15 is moved slowly and continuously along the shift axis Y in order to continuously use unused regions of the grinding wheel 16 for machining (so-called shifting movement).

In parallel to the workpiece machining, the finished workpiece is removed from the other workpiece spindle and another blank is clamped on this spindle.

### Introduction of Vibrations During Continuous Generating Grinding

In the process proposed here, an externally excited oscillating movement is introduced into the generating grinding process. By suitable selection of the amplitude, frequency and phase position of the oscillating movement, positive effects can be achieved with regard to the structure of the workpiece surface.

In cylindrical and surface grinding, ultrasonic vibrations have been used on various occasions to reduce grinding forces, minimize tool wear and optimize the workpiece surface in terms of structure and roughness parameters (see documents [3]-[24]). With the superposition of ultrasonic vibrations, the continuous contact between tool and workpiece becomes discontinuous, and/or the trajectory of the abrasive grains is changed. This can result in advantages in terms of productivity and quality. However, due to the completely different kinematics and contact conditions in continuous generating grinding, knowledge gained in surface or cylindrical grinding cannot be transferred to continuous generating grinding.

In the process proposed here, the process kinematics of generating grinding is superimposed in a suitable manner with oscillating movements in the ultrasonic range (above 15 kHz) or in the low-frequency range (below 15 kHz). This is intended to reduce the waviness of the ground tooth flank surface and to avoid or interrupt regular grinding grooves. Other objectives are to reduce process forces and tool wear. This makes it possible to subject grinding processes to a higher intensity in the future (e.g. shortening the grinding time by increasing the axial feed), since the individual grain is subjected to less stress and the grinding forces are reduced. When oscillating movements with frequencies below the ultrasonic range are superimposed, there is the potential for suppressing chatter frequencies.

Within the framework of the procedure proposed here, the oscillating movements are generated on the workpiece. For this purpose, the clamping device for the workpiece (hereinafter also referred to as clamping set) can be equipped with an actuator system for generating vibrations.

### Vibration Directions

Three main directions are possible for aligning the oscillating movements with respect to the conventional cutting direction in continuous generating grinding. Table 1 shows these three main directions for the example case of machining a spur gear.

TABLE 1
Assignment of the three main directions of superimposed
oscillating movements during grinding of a spur gear

| Type of | Vibration direction | |
|---|---|---|
| vibration | of the workpiece | |
| superposition | (spur gear) | Effect on the process kinematics |
| In cutting | Longitudinal (axial) | Varying cutting speed, such that |
| direction | in the axial direction | cutting speed is temporarily |
| | of the workpiece | increased, and possible |
| | | interrupted cut |
| Transverse to | Radial to the | Straight-line trajectory of the |
| the cutting | workpiece axis | grain mesh is superposed in the |
| direction | | plane of the tooth flank surface |
| | | with vibration form |
| In cutting depth | Torsional around the | Depth of cut varies until lift-off |
| | workpiece axis | and interruption of the meshing |
| | | contact |

Combinations of these three main directions are also possible and useful. On real systems, such combinations are even unavoidable to a certain extent. This is especially true for helical gears.

### Vibration Frequencies

With regard to the frequency range, a distinction can be made between low-frequency vibrations (below 15 kHz) and high-frequency vibrations in the ultrasonic range (above 15 kHz). The influences on the process can be very similar and pursue the same objectives. With regard to the generation of vibrations, however, there are different practical implementation variants for the different frequency ranges.

For the generation of ultrasonic vibrations, the use of the natural structural dynamics of the structure to be excited, consisting of gear and clamping set, is proposed. Typically, usable eigenmodes lie in the frequency range of ultrasound due to the mass and stiffness distribution of such structures and can also be optimized and adapted by design measures. Advantages of excitation in resonance are, for example, the possibility to spatially separate the actuator for excitation from the active point of the process, the maintenance of a relatively high stiffness of the structure and a high efficiency for generating the vibration amplitudes in the active point of the process. Examples of integrating a vibration transducer into the clamping set to achieve these goals are discussed in further detail below.

For the generation of low-frequency vibrations, there is usually no possibility of resonant excitation. The structural dynamics of the clamping set and gear wheel usually do not permit resonant excitation in the low-frequency frequency range or their stiffness would have to be reduced to such an extent that they would no longer be usable for the process. For the generation of low-frequency oscillations, a non-resonant excitation is therefore proposed. By means of a suitable arrangement of actuators and a connecting kinematic system for translating and transmitting the deflections, the gear wheel can also be set into low-frequency oscillations without using resonance.

### Eigenmodes of Ultrasonic Vibrations

In order to couple ultrasonic oscillations specifically into the active point of the process, it is intended in some embodiments to excite natural eigenmodes in resonance and thus to excite standing waves (resonance excitation). An eigenmode in this case is characterized by regions of so-called vibration antinodes with maximum deflection and, at the same time, minimum strain. Opposite regions with minimum mechanical deflection and maximum mechanical strain are called vibration nodes.

Preferably, the workpiece (gear) and the workpiece clamping device (clamping set) are excited as a common oscillating structure in suitable eigenmodes. In this case, eigenmodes are preferably used which lead to largely uniform deflections around the entire circumference of the gear. Otherwise, and in the case of oscillating modes whose alignment is random, as is the case, for example, for bending oscillations with respect to the axis C of the workpiece and the clamping set, the oscillation generated in the active point would be subject to randomness, and process reliability could not be guaranteed.

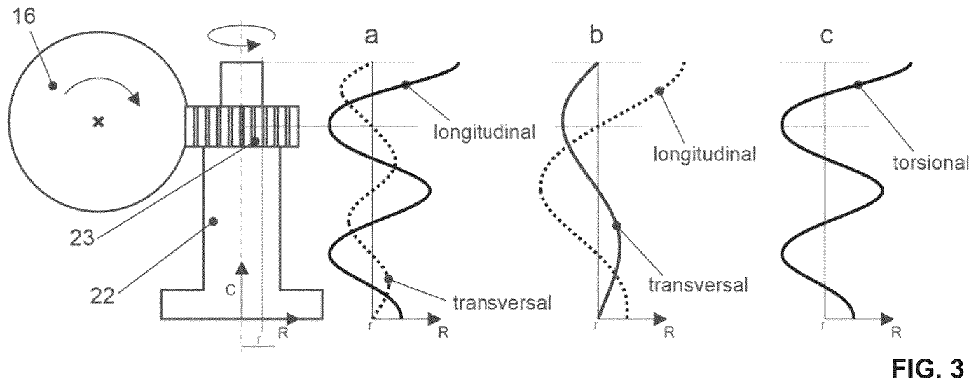

In FIG. 3, three possible vibration modes for achieving the differently directed oscillating movements of a gear 23 in the three main directions described above from Table 1 are idealized and sketched for the case of a spur gear 23.

For the superposition in the cutting direction (diagram a in FIG. 3), the clamping set 22 together with the gear 23 is excited in an eigenmode with a longitudinal vibration in the direction of the gear axis (workpiece axis C). The order of the mode is selected and the structure is designed in such a way that an vibration antinode of the longitudinal vibration is formed in the area of the gear 23. This means that maximum amplitudes in the axial direction of the gear 23 act at the active point of the process and thus in the cutting direction.

In geometrically limited structures, a longitudinal vibration is always accompanied by a transverse vibration (thickness vibration) due to transverse contraction. We speak of “quasi-longitudinal” oscillations. In this case, maximum transverse deflections occur at the points of maximum longitudinal strain. This means that a vibration node of a real longitudinal vibration shows no longitudinal displacements, but displacements transverse to it. This behavior can be used in the case of generating grinding for superposition in the cutting plane transverse to the cutting direction. This form of vibration excitation is sketched in diagram b in FIG. 3 and is characterized by a longitudinal vibration node in the region of the gear 23.

For superposition in the direction of the cutting depth, the rotationally symmetrical structure consisting of gear 23 and clamping set 22 can be excited in a torsional mode about the workpiece axis C, with a torsional vibration antinode placed in the region of gear 23. This form of vibration is sketched in diagram c of FIG. 3.

Via the type of vibration generator (thickness transducer or shear transducer), its positioning, the geometry of the end mass and via the selection of the eigenmode (via excitation frequency), the various types of vibration superposition and also combinations thereof may be implemented. So-called operating vibration modes, as they occur on real structures, always exhibit a certain degree of combinations of different directional components of the idealized vibration directions.

Integration of the Vibration Generator into the Clamping Device

To generate the vibrations, a vibration generator is preferably integrated into the clamping set. The vibration generator preferably comprises one or more piezoelectric actuators which convert an electrical control corresponding to the operating frequency into mechanical vibrations. The placement and orientation of the vibration generator determines the vibration parameters achieved on the surface of the tooth flanks to be machined and can be configured according to the intended type of vibration superposition.

For effective vibration excitation, the actuators are preferably positioned near a vibration node for the eigenmode to be excited. In this case, the mechanical direction of action of the actuators is in the direction of the strain of the vibration mode at the position of the actuators. Preferably, several thin actuators are used as actuator stacks with interposed, alternately poled electrodes for voltage supply. With this setup, the required electric field strengths are achieved with relatively low electric voltages.

To protect the machine components connected to the clamping set and to avoid undesirable vibration transmission to the remaining structures of the generating grinding machine, it makes sense to decouple the vibration of the clamping set with the gear from the rest of the machine. For this purpose, a vibration mode is preferably selected which has a vibration node in the region where the clamping set is connected to the workpiece spindle. The vibration transmission can be further reduced by giving the clamping set a high mass in the mounting region and/or by providing geometries for reduced vibration transmission.

A frequency generator can be used to supply the actuators with an excitation signal in the form of an electrical AC voltage at the desired excitation frequency. The excitation frequency generated corresponds to the resonance frequency of the eigenmode to be excited. The resonant frequency depends in certain ranges on influences such as temperature and the acting process force. In order to always excite in a favorable operating range and with high efficiency, the frequency of the frequency generator should preferably be controlled with a controller. Frequency generator and controller can be integrated into one control device. This allows the output excitation frequency to be adjusted to the variable resonance frequency of the system. Furthermore, the ultrasonic power is preferably regulated so that desired amplitudes can be introduced into the process independently of the load.

To control the vibration amplitude and to adjust the excitation frequency, the actual vibration of the gear can be recorded in frequency, phase position and/or amplitude. Since the oscillating movement of the tooth flanks in the process cannot be readily detected directly, an indirect measurement may be made and may allow conclusions to be drawn about the vibration at the gear. Assuming the correct eigenmode is excited, a single sensor may provide the actual values for the oscillation at the tooth flanks. A statement as to whether excitation is actually in the desired mode is only possible to a limited extent with the single sensor. With the arrangement of several sensors at characteristic points, with the phase position of the sensor signals and with the comparison of the measured amplitudes, the excited three-dimensional vibration mode can also be determined. This can ensure vibration excitation in the desired eigenmode and increase process stability in controlled vibration operation. Piezoelectric elements, from which a voltage signal can be tapped, can also be provided as sensors.

Both the electrical supply to the actuators and the sensor signals are transmitted between the rotating clamping set with the gear and the stationary control device. A contactless rotary transformer with inductive power transmission can be provided for this purpose, for example.

Example 1: Generation of Torsional Vibrations with Vibration Generator Above the Gear Wheel

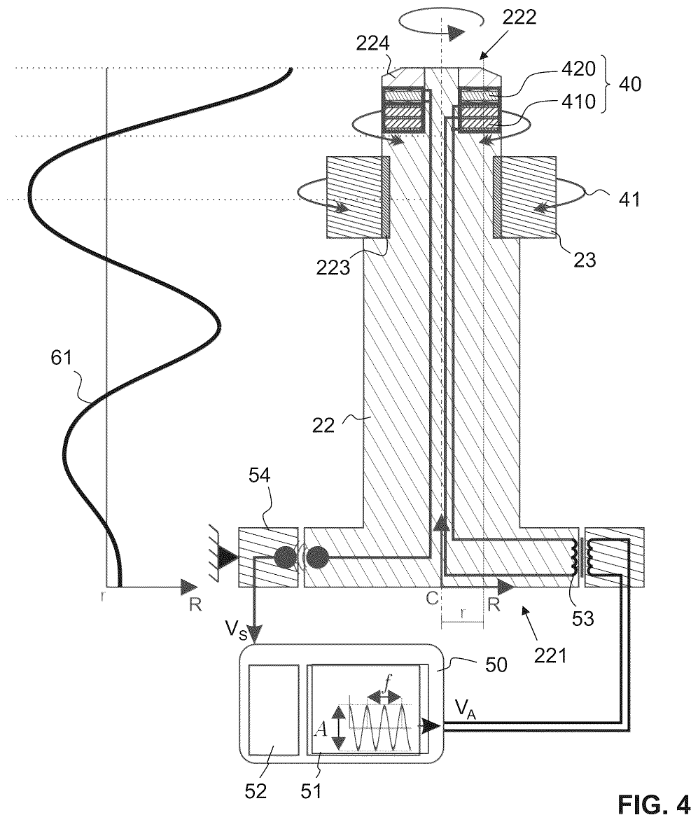

An example of how the principles explained above can be put into practice is now explained with reference to FIG. 4.

In FIG. 4, a clamping set 22 for rigid connection to the rotating shaft of a workpiece spindle is shown in a highly schematic manner. The end of the clamping set which is intended for connection to the spindle shaft is hereinafter referred to as the proximal end 221, and the opposite end 222 is referred to as the distal end. In FIG. 4, the proximal end is at the bottom and the distal end is at the top. The clamping set 22 has a clamping portion 223 in the form of a radially expandable expansion sleeve or segmented clamping bushing, on which a gear-shaped workpiece 23 is clamped. Above the workpiece 23 (axially between the clamping portion 223 and the distal end 222), a vibration transducer 40 is integrated into the clamping set. Above the vibration transducer 40 (distal from the vibration transducer 40), the clamping set 22 has a replaceable end piece 224 in the form of a preload nut. This end piece 224 fixes the vibration transducer 40 to the clamping set 22 and at the same time compresses it in axial direction along the workpiece axis C.

As will be explained in more detail below, the vibration transducer 40 comprises, on the one hand, a vibration generator 410 which is driven by a high-frequency excitation signal V_{A} to excite torsional vibrations 41 of the workpiece 23. On the other hand, the vibration transducer 40 includes a vibration sensor 420 to measure characteristics of the generated vibrations. The vibration sensor 420 outputs one or more sensor signals V_{S} output.

A control device 50 is used to read out the vibration sensor 420 and to control the vibration generator 410 based thereon. The control device 50 comprises on the one hand a frequency generator 51 to generate the excitation signal V_{A} for the actuator 410. On the other hand, the control device 50 comprises a controller 52 which receives the sensor signals V_{S} and which controls the frequency f and amplitude A of the excitation signal V_{A} on the basis of these sensor signals. The electrical output and input signals of the vibration transducer 40 are transmitted through electrical connections inside the clamping set 22. An inductive transmission device 53, shown only schematically, is used for contactless transmission of the excitation signal V_{A} from the control device 50 to the clamping set 22. A further transmission device 54 is used for transmitting the sensor signals V_{S} from the clamping set 22 to the control device 50. For example, the transmission can be effected inductively by two coils arranged concentrically around the workpiece axis, one of the coils being arranged on the clamping device and the other coil on the stationary machine element. In particular, arrangements can be used as known from Refs. [31] or [32] in another context.

In the present example, the vibration generator 410 generates a torsional vibration about the workpiece axis C. The frequency of this torsional vibration is controlled by the controller 52 in such a way that the unit consisting of clamping set 22 and workpiece 23 is resonantly excited. In the simplest case, the excitation frequency f is controlled by the controller 52 in such a way that the amplitude A measured by the vibration sensor 420 becomes maximum.

A standing wave with vibration nodes (i.e. points where the amplitude of the torsional vibration is minimum) and vibration antinodes (i.e. points where the amplitude of the torsional vibration has a local maximum) forms along the workpiece axis C. The amplitude distribution of this standing wave along the workpiece axis is illustrated in the left part of FIG. 4 as an amplitude distribution 61 at a radius R being non-zero. The clamping set 22 is configured in such a way that the standing wave has a vibration antinode in the region of the workpiece 23, while the vibration generator 410 is arranged near a vibration node. In the present example, the vibration generator 410 is arranged near the first vibration node above the gear 23, which contributes to a particularly large amplitude of the resulting torsional vibration at the vibration antinodes. In order to minimize the transmission of the torsional vibrations to the workpiece spindle, the clamping set 22 is configured such that a vibration node is located at its proximal end 221, i.e. where the clamping set 22 is connected to the spindle shaft.

The geometric design of the clamping set 22 and the positioning of the vibration generator 410 in such a way that resonant excitation can take place and that the vibration antinodes and nodes are located at the desired points can be easily achieved with the aid of known simulation methods of vibration behavior, in particular FEM simulations. Since the workpiece 23 forms part of the resonantly vibrating structure, the design of the clamping set 22 and the positioning of the vibration generator 410 are in principle workpiece-specific. However, once a clamping set 22 has been designed, it can nevertheless be used within certain limits for different workpieces 23 by adapting the excitation frequency f to the workpiece in such a way that resonant excitation takes place.

### Structure of a Vibration Transducer

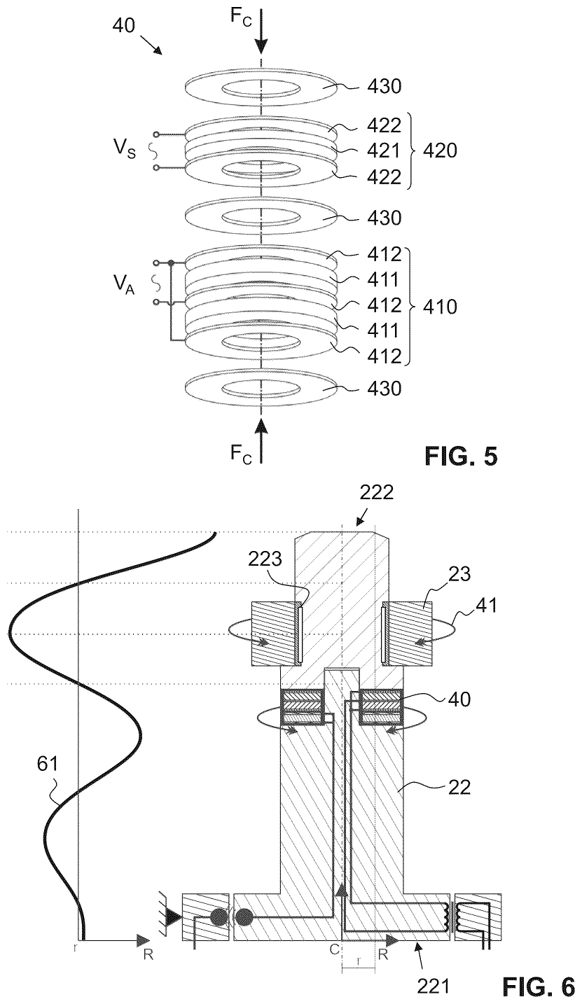

The structure of a suitable vibration transducer 40 is illustrated by way of example in FIG. 5. The vibration transducer 40 comprises a stack of flat, disk-ring shaped elements. The stack has two regions. A first, lower region forms a vibration generator 410, and a second, upper region forms a vibration sensor 420.

In the present example, the vibration generator 410 comprises two annular piezoelectric shear actuators 411 arranged axially one above the other, between which a central annular electrode 412 is arranged. Above the upper shear actuator and below the lower shear actuator, an outer annular electrode 412 is arranged at each of the two axial ends of the vibration generator 410. The two outer electrodes are electrically connected to each other. The shear actuators are both identically built, but are arranged mirrored with respect to each other with respect to a horizontal plane passing through the central electrode 412.

Shear actuators per se are known from the prior art. They exploit the fact that in many piezoelectric materials the piezoelectric shear deformation coefficient d₁₅ is non-zero. In the present case, the shear actuators 411 are configured to produce a shear deformation in the circumferential direction under the action of an electric field extending along the workpiece axis C. The direction of action of the actuators about their axis C can be achieved by a special polarization process in which the closed ring is polarized segment by segment about the circumference. Actuators that produce shear deformation in the circumferential direction are described, for example, in Refs. [33]-[36].

When a voltage is applied between the outer electrodes and the central electrode, both shear actuators 411 generate a shear force along the circumferential direction in the same direction. Overall, this creates a torque between the upper end and the lower end of the vibration generator 410. By driving the shear actuators with an AC voltage, a torsional vibration can be generated.

The vibration sensor 420 is basically built in a very similar fashion. In the present example, it has only a single annular piezoelectric element which generates an output voltage under the action of a shear deformation between its lower surface and its upper surface acting in the circumferential direction.

The vibration generator 410 and the vibration sensor 420 are electrically isolated from each other by insulating washers 430. Via the end piece 224, which is configured as a preload nut, the stack of ring-disk-shaped elements can be subjected to a compressive force Fc along the axial direction.

### Alternative Vibration Directions and Arrangements

FIG. 6 shows an alternative arrangement for exciting torsional vibrations. The vibration transducer 40 is located axially between the proximal end 221 of the clamping set 22 and the clamping portion 223 for the workpiece 23. As in the previous example, the vibration transducer 40 is arranged in the area of a vibration node. By means of a suitable preloading device, an axial preload can also be generated on the vibration transducer 40 in this embodiment.

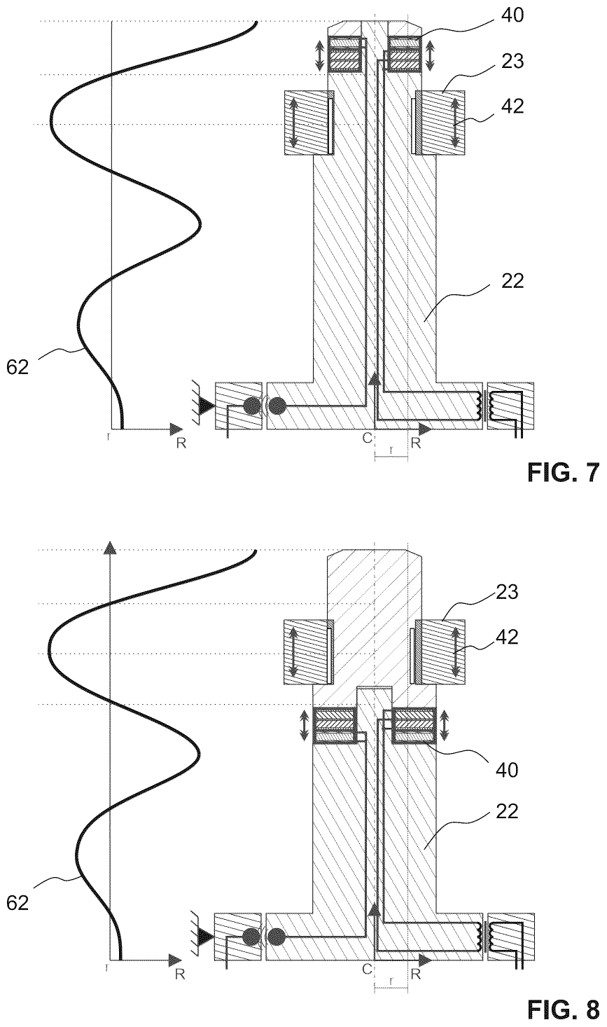

The arrangement of FIG. 7 is similar in construction to the arrangement of FIG. 4, and reference is made to the description above in this regard. Unlike in FIG. 4, however, the vibration transducer 40 is configured to generate primarily a longitudinal vibration 42 of the workpiece 23. Again, resonant excitation takes place. On the left side of FIG. 7, the resulting amplitude distribution of the longitudinal vibration components 62 is sketched in the direction of the C axis of the workpiece and the clamping set. Analogous to the embodiments of FIGS. 4 and 6, the vibration transducer 40 is arranged in the region of a (here longitudinal) vibration node. In this embodiment, annular thickness actuators may be used as piezo actuators by utilizing the piezoelectric longitudinal deformation coefficient d₃₃.

In the embodiment of FIG. 8, a longitudinal vibration of the workpiece 23 is also excited. In this embodiment, the vibration transducer 40 is located in the region of a longitudinal vibration node below the workpiece 23, between the proximal end of the clamping set 22 and the clamping portion for the workpiece.

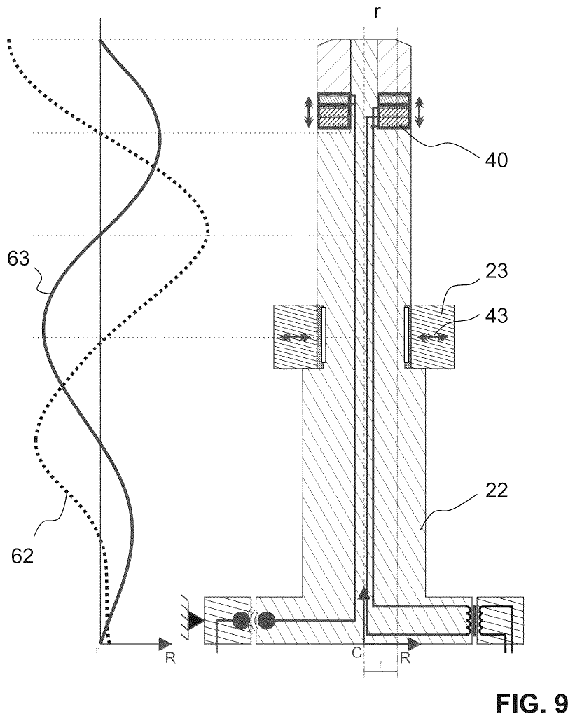

In the embodiment of FIG. 9, a transverse (radial) vibration 63 of the gear 23 is excited, the amplitude of the vibration being the same over the entire circumference of the gear at all times. Since a longitudinal vibration is always accompanied by a transverse contraction, a longitudinally acting vibration transducer can be used to cause the radial vibration 63 in the region of the workpiece 23, as already explained above in the context of FIG. 3. On the left side of FIG. 9, the longitudinal amplitude distribution 62 and the transverse amplitude distribution 63 are schematically sketched at a radius R being non-zero. The vibration transducer 40 is arranged in the region of a longitudinal node. The workpiece 23 is arranged in the region of the adjacent longitudinal node and thus in the region of a transverse vibration antinode.

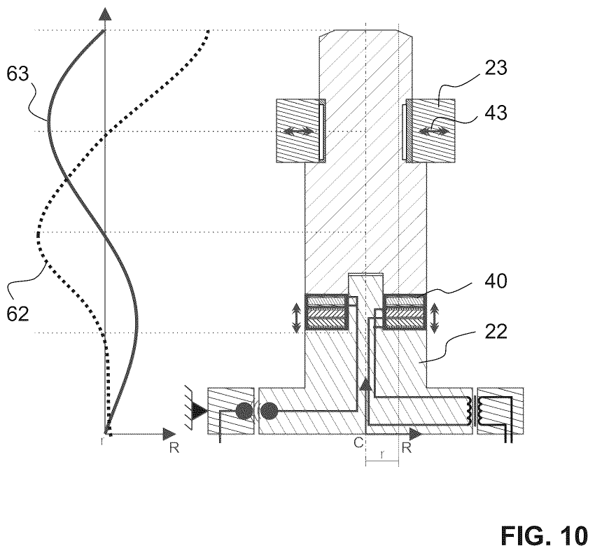

Also in the embodiment of FIG. 10, excitation of a radial vibration 63 of the gear 23 is performed by means of a longitudinally acting vibration transducer 40. In this embodiment, the vibration transducer 40 is arranged near a longitudinal vibration node between the proximal end of the clamping set 22 and the clamping point for the workpiece 23.

### Modifications

While the invention has been explained above by way of examples, the invention is not limited to these examples, and a wide variety of variations are possible without departing from the scope of the invention.

For example, other types of vibration generators than those explained above may be used. Also, more than one single vibration generator may be used per clamping set. Likewise, a vibration generator may include a number of actuators being different from two. For example, multiple vibration generators may be located at different axial locations to selectively generate specific vibration shapes. The vibration shapes generated may be more complex than in the examples explained above and may include, for example, superpositions of longitudinal, radial and torsional vibrations.

The same applies to the vibration sensors. As already explained, several vibration sensors may be present at different axial locations in order to characterize the type of vibration and its amplitude distribution more precisely.

In case the vibration generators and/or vibration sensors comprise flat, disk-ring-shaped piezoelectric elements as in the foregoing examples, a plurality of such elements may be stacked on top of each other with electrodes interposed therebetween.

Instead of disk-ring-shaped piezoelectric elements, piezoelectric elements of other shapes may also be used. In particular, ring-segment-shaped elements may be used, which are arranged as a whole to form a ring, or elements of any other shape may be used, which are arranged in an evenly distributed manner over the circumference of the clamping set.

### LITERATURE

[1] H. Schriefer et al, “Continuous Generating Gear Grinding”, Eigenverlag Reishauer A G, Wallisellen 2010, ISBN 978-3-033-02535-6, chapter 2.3 (“Basic Methods of Generating Grinding”), pages 119 to 127
[2] U.S. Pat. No. 6,379,217B1
[3] DE885525C
[4] DE102007047891A1
[5] DE10335376A1
[6] T. Tawakoli, B. Azarhoushang, and M. Rabiey, “Ultrasonic assisted dry grinding of 42CrMo4,” Int J Adv Manuf Technol, vol. 42, 9-10, pp. 883-891, 2009, doi: 10.1007/s00170-008-1646-7.
[7] H. Chen and J. Tang, “Influence of ultrasonic assisted grinding on Abbott-Firestone curve,” Int J Adv Manuf Technol, vol. 86, 9-12, pp. 2753-2757, 2016, doi: 10.1007/s00170-016-8370-5.
[8] H. Chen, J. Tang, X. Lang, Y. Huang, and Y. He, “Influences of dressing lead on surface roughness of ultrasonic-assisted grinding,” Int J Adv Manuf Technol, vol. 71, 9-12, pp. 2011-2015, 2014, doi: 10.1007/s00170-014-5636-7.
[9] H. Chen, J. Tang, W. Shao, and B. Zhao, “An investigation on surface functional parameters in ultrasonic-assisted grinding of soft steel,” Int J Adv Manuf Technol, vol. 97, 5-8, pp. 2697-2702, 2018, doi: 10.1007/s00170-018-2164-x.
[10] D.-H. Xiang, Z.-Y. Liu, Z.-K. Zhou, and Y.-I. Yao, “Experimental study of single cubic boron nitride grains in ultrasound-assisted high-speed grinding,” Advances in Mechanical Engineering, vol. 9, no. 2, 168781401769354, 2017, doi: 10.1177/1687814017693543.
[11] S. Sun, J. Tang, W. Shao, C. Chen, and Y. Liu, “Research on the matching relationship between ultrasonic-assisted grinding parameters and workpiece surface roughness,” Int J Adv Manuf Technol, vol. 102, 1-4, pp. 487-496, 2019, doi: 10.1007/s00170-018-3195-z.
[12] H. Chen and J. Tang, “A model for prediction of surface roughness in ultrasonic-assisted grinding,” Int J Adv Manuf Technol, vol. 77, 1-4, pp. 643-651, 2015, doi: 10.1007/s00170-014-6482-3.
[13] W. Zhou, J. Tang, H. Chen, and W. Shao, “A comprehensive investigation of surface generation and material removal characteristics in ultrasonic vibration assisted grinding,” International Journal of Mechanical Sciences, vol. 156, pp. 14-30, 2019, doi: 10.1016/j.ijmecsci.2019.03.026.
[14] U.S. Pat. No. 5,540,614A
[15] H. Kitzig-Frank, T. Tawakoli, and B. Azarhoushang, “Material removal mechanism in ultrasonic-assisted grinding of Al₂O₃ by single-grain scratch test,” Int J Adv Manuf Technol, yr. 91, 9-12, pp. 2949-2962, 2017, doi: 10.1007/s00170-016-9967-4.
[16] DE102009017248A1
[17] U.S. Pat. No. 5,165,205A
[18] JPS63278751A
[19] C. Brecher, R. Schug, A. Weber, C. Wenzel, and S. Hannig, “New systematic and time-saving procedure to design cup grinding wheels for the application of ultrasonic-assisted grinding,” Int J Adv Manuf Technol, yr. 47, 1-4, pp. 153-159, 2010, doi: 10.1007/s00170-009-2204-7.
[20] T. Tawakoli and B. Azarhoushang, “Dry grinding of soft steel with use of ultrasonic vibrations.” The 6th International Conference on Manufacturing Research (ICMR08), Brunel University, UK, 2008.
[21] T. Taghi and A. Bahman, “Entwicklungen im ultraschallunterstützten Schleifen für Keramik- und Metallwerkstoffe Verfahren und Maschinen” in Jahrbuch Schleifen, Honen, Läppen und Polieren: Verfahren und Maschinen, H.-W. Hoffmeister und B. Denkena, Hg., 66 Aufl. Essen: Vulkan-Verl., 2013.
[22] DE102008054309A1
[23] G. Sun, F. Shi, and Z. Ma, “Effects of axial ultrasonic vibration on grinding quality in peripheral grinding and end grinding of ULE,” Int J Adv Manuf Technol, vol. 109, 7-8, pp. 2285-2298, 2020, doi: 10.1007/s00170-020-05761-5.
[24] DE10060696 A1
[25] H. Kitzig, T. Tawakoli, and B. Azarhoushang, “A novel ultrasonic-assisted dressing method of electroplated grinding wheels via stationary diamond dresser,” Int J Adv Manuf Technol, yr. 86, 1-4, pp. 487-494, 2016, doi: 10.1007/s00170-015-8156-1.
[26] JP2002144150A
[27] JPH02124221A
[28] CN108746875A
[29] CN208913295U
[30] US2013280990A1
[31] U.S. Pat. No. 7,641,537B2
[32] US2016217364A1
[33] Research report “Hochleistungsbearbeitung von schwer spanbaren Werkstoffen durch hybride ultraschallunterstützte Zerspanung (ULTRASPAN)”, 2018.
[34] T. Morita et al, “A smooth impact rotation motor using a multi-layered torsional piezoelectric actuator,” IEEE Trans Ultrason Ferroelectr Freq Control, 46(6), pages 1439-1445, 1999, doi: 10.1109/58.808867.
[35] A. E. Glazounov et al, “Torsional actuator based on mechanically amplified shear piezoelectric response,” Sensors and Actuators 79, pages 22-30, 2000, doi: 10.1016/S0924-4247(99)00250-2.
[36] T. Harada et al, “Droplet generation using a torsional Langevin-type transducer and a micropore plate”, Sensors and Actuators A: Physical, Volume 155, Issue 1, Pages 168-174, 2009, doi: 10.1016/j.sna.2009.08.007

1. A method for machining a gear-shaped workpiece by a generating machining process in which the gear-shaped workpiece rotates about a workpiece axis while it is in generating mesh with a generating machining tool, in particular with a worm shape profiled grinding tool, characterized in that the gear-shaped workpiece is specifically excited during machining to carry out an oscillating movement which is superimposed on the rotation of the gear-shaped workpiece.

2. The method of claim 1, wherein the oscillating movement comprises a component along at least one of the following directions of movement:
axial along the workpiece axis;
radial to the workpiece axis; and
torsional about the workpiece axis.

3. The method of claim 1, wherein the oscillating movement has a fundamental frequency above 15 kHz.

4. The method of claim 1,
wherein the gear-shaped workpiece is clamped on a clamping device during the generating machining,
wherein the clamping device is arranged on a workpiece spindle,
wherein the clamping device has a clamping portion at which the clamping device is in contact with the gear-shaped workpiece,
wherein the workpiece spindle drives the gear-shaped workpiece clamped on the clamping device to rotate about the workpiece axis, and
wherein the oscillating movement of the gear-shaped workpiece is generated by exciting a vibration of the clamping portion with the gear-shaped workpiece being in contact therewith.

5. The method of claim 4, wherein the excitation of the vibration is resonant such that the vibration is an eigenmode of the clamping device with the gear-shaped workpiece clamped thereon.

6. The method of claim 4, wherein the clamping device comprises a vibration generator for exciting the vibration.

7. The method of claim 6,
wherein an electrical excitation signal is supplied to the vibration generator,
wherein at least one electrical sensor signal is determined which characterizes the vibration caused by the excitation signal, and
wherein the excitation signal is controlled on the basis of the sensor signal in such a way that the excitation of the vibration is resonant.

8. The method of claim 7, wherein the excitation signal and the sensor signal are transmitted in a contactless manner between the rotating clamping device and a stationary control device.

9. A clamping device for clamping a gear-shaped workpiece on a workpiece spindle of a generating machining machine, in order to drive the gear-shaped workpiece to rotate about a workpiece axis,
wherein the clamping device has a clamping portion in which the clamping device is in contact with the gear-shaped workpiece,
characterized in that the clamping device comprises a vibration generator for generating a vibration of the clamping portion with the gear-shaped workpiece being in contact therewith.

10. The clamping device of claim 9, wherein the vibration generator is configured to generate a vibration excitation along at least one of the following directions of movement:
axial along the workpiece axis;
radial to the workpiece axis; and
torsional about the workpiece axis.

11. The clamping device of claim 9,
wherein the vibration generator comprises at least one piezo actuator.

12. The clamping device of claim 11, wherein the vibration generator comprises at least one piezoelectric actuator element which is disk-ring-shaped or ring-segment-shaped, wherein a ring axis of the piezoelectric actuator element corresponds to the workpiece axis.

13. The clamping device of claim 9,
wherein the clamping device defines a proximal end and a distal end,
wherein the proximal end is adapted to be connected to the workpiece spindle, and
wherein the vibration generator is disposed between the proximal end and the clamping portion or distally from the clamping portion.

14. The clamping device of claim 2, further comprising a vibration sensor for determining at least one sensor signal characterizing the vibration of the clamping device with the gear-shaped workpiece clamped thereon.

15. The clamping device of claim 14,
wherein the vibration sensor comprises a piezo sensor.

16. The clamping device of claim 15, wherein the vibration sensor comprises at least one piezoelectric sensor element which is disk-ring-shaped or ring-segment-shaped, wherein a ring axis of the piezoelectric sensor element corresponds to the workpiece axis.

17. A system for generating an oscillating movement of a gear-shaped workpiece during machining by continuous generating grinding, comprising:
a clamping device according to claim 10; and
a frequency generator for generating an excitation signal for the oscillation generator to cause the vibration of the clamping device with the gear-shaped workpiece clamped thereon.

18. The system of claim 17, further comprising:
a transmission device for contactless transmission of the excitation signal between the rotating clamping device and the control device.

19. A generating machining machine comprising:
a tool spindle for driving a generating machining tool to rotate about a tool axis;
a workpiece spindle for driving the gear-shaped workpiece to rotate about the workpiece axis; and
a machine controller configured to control the tool spindle and the workpiece spindle in such a way that a roll coupling is established between the rotation of the generating machining tool generated by the tool spindle and the rotation of the workpiece generated by the workpiece spindle,
characterized in that a clamping device according to claim 9 is mounted on the workpiece spindle.

20. The method of claim 1, wherein the generating machining tool is a worm-shape profiled grinding tool.

21. The method of claim 5, wherein the eigenmode has a node of vibration where the clamping device is connected to the workpiece spindle.

22. The system of claim 17, further comprising a controller configured to receive a sensor signal and, on the basis of the sensor signal to control the excitation signal in such a way that the excitation of the vibration occurs resonantly and with a predetermined amplitude.

23. The system of claim 18, wherein the transmission device is further configured for contactless transmission of the sensor signal between the rotating clamping device and the control device.

24. The generating machining machine of claim 19, wherein the machine is a generating grinding machine and wherein the machining tool is a worm-shape profiled grinding tool.
